(19) United States
(12) Patent Application Publication
(10) Pub. No.: US 2022/0400624 A1
(43) Pub. Date: Dec. 22, 2022

(54) Planting bag

(71) Applicant: Peter Cordani, Jupiter, FL (US)

(72) Inventor: Peter Cordani, Jupiter, FL (US)

(21) Appl. No.: 17/663,036

(22) Filed: May 12, 2022

Related U.S. Application Data
(60) Provisional application No. 63/212,028, filed on Jun. 17, 2021.

(51) Int. Cl. A01G 9/029; A01G 24/50; A01G 29/00

(52) U.S. Cl. CPC A01G 9/0291; A01G 24/50; A01G 29/00

(57) ABSTRACT

A planting bag formed from biodegradable material and sized for receipt of a planting. The planting bag having a water delivery system comprising at least two distribution lines secured to the bag and a splitter for coupling to a conventional water hose. A fertilizer admixture and water absorbing polymer are impregnated into the side wall of the bag allowing close proximity to the root ball of the planting to minimize the loss of fertilizer and provide a means for directing water around the planting root ball.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 63/212,028, entitled “PLANTING BAG”, filed Jun. 17, 2021. The contents of which the above referenced application is incorporated herein by reference.

### FIELD OF THE INVENTION

The field of the invention is agricultural plantings and, in particular, to a planting bag to facilitate the transfer of plants through the controlled release of nutrients.

### BACKGROUND OF THE INVENTION

When plants, bushes, trees and the like agricultural products are transplanted, it is common for the top of the roots receive fertilizers and copious amounts of water. While surface placed fertilizer helps produce better agricultural products, improper application of fertilizer has some serious side-effects. While placement of fertilizer on top of soil helps treat the underlying vegetation, a majority of the fertilizer can be easily flushed away by rain or excess watering. The concern is that the fertilizer runoff enters sewers, streams, ponds, waterways and other areas indiscriminately. Fertilizer runoff is a known pollutant that can dramatically affect drinking water supplies. Further, loss of fertilizer increases the amount of fertilizer that is necessary to effectively treat a planting.

Fertilizer runoff can result in the creation of oxygen-depleted areas where aquatic life cannot survive dead zones which are. Fertilizer runoff is increasing the number, size, duration and severity of dead zones throughout the U.S. water supplies.

Water absorbent polymers are also known to be used in connection with new plantings, and can be used in combination with fertilizers. Water absorbent polymers are able to store many times their own weight in water, serving as water reservoirs to provide moisture to the new planting. The stored water is extracted from the polymer and absorbed by the plant. Properly applied, super absorbent polymer can reduce the amount of water lost through percolation, evaporation and runoff and thereby reduce the leaching of soil nutrients, Herbicides, Pesticides, Fungicides and the like. Water absorbent polymers can easily be washed away if excess water is present and the polymers are only placed along the top soil.

What is lacking in the industry is a biodegradable planting bag having a pre-calculated amount of nutrients to facilitate protection of the roots during plant transfer, and bag having water distribution capability to place water around the root ball of the planting.

### SUMMARY OF THE INVENTION

Disclosed is a planting bag, formed of degradable material, to enclose the roots of a planting. During relocation of a planting, the root ball of the planting is placed with the planting bag which contains fertilizer and water absorbable polymer impregnated into the side of the planting bag. The planting bag having a framework of vertical tubes attached to a hose ring at the upper rim of the planting bag. The hose ring is releasably securable to a conventional garden hose to allow the tubes to be filled during transportation and/or upon planting. The hose ring is filled from above ground once the planting is inserted into the ground. Water placed within the tubes saturates the roots of the planting. The planting bag may include other nutrients including Herbicides, Pesticides, Fungicides, Nematode control, Root based nematode defense, Mite Control and the like which facilitate growth of the planting both in transportation as well as insertion into a pot or the ground. The planting bag is bio-degradable leaving only a water system in position.

An objective of the invention is to provide a biodegradable bag having fertilizers and polymers impregnated in the bag side wall to provide a planting bag with the proper nutrients positioned adjacent to the plant root ball.

Another objective of the invention is to provide embedded fertilizers, gel polymers and other agents into the structure of the bag for controlled dispersal into the soil at the root area of a newly relocated planting.

Another objective of the instant invention is teach the use of a planting bag having a water system employing a garden hose connection fluidly coupled to a plurality of perforated vertical tubes secured to the side wall of the planting bag for providing irrigation to the root portion of the plant once the bag is inserted into the soil, or if needed during transportation of the new planting.

Still another objective of the invention is a planting bag with embedded nutrients to provide even distribution of the nutrients to the root ball of a planting.

Yet still another objective of the invention is to attach fertilizers to a planting bag which is buried in the soil to inhibit the fertilizers from washing away.

Another objective of the invention is to teach use of an impregnated bag with a water system that eliminates the need for calculating the proper amount of nutrients to be added to a new planting while in the field.

Still another objective of the invention is eliminate the need for carrying bags of nutrients to a place of planting by providing a planting bag having the proper amount of nutrients and the like agents fully prepared.

Other objectives and advantages of this invention will become apparent from the following description, taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a perspective view of a planting bag of the instant invention;

FIG. 2 is a top view of the garden hose ring with a splitter for coupling to a conventional water hose; and

FIG. 3 is a front view of the garden hose ring with hose fitting attached and illustrating irrigation lines depending therefrom.

### DESCRIPTION OF THE PREFERRED EMBODIMENT

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

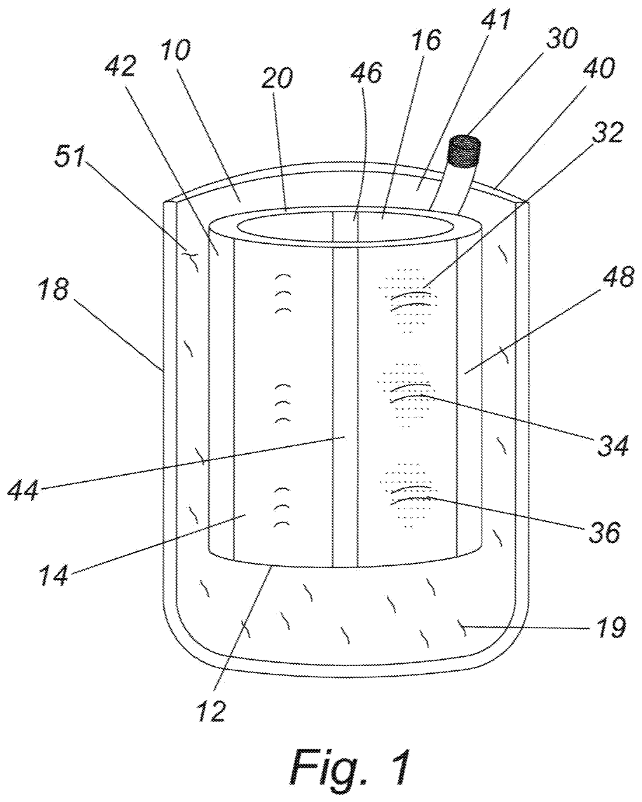

As shown in FIG. 1, a planting bag 10 having a bottom wall 12, a continuous side wall 14 secured to said bottom wall 12, and an open top 16. The planting bag 10 is inserted vertically into a planting container 18 filled with soil 19, or into the ground. The planting bag 10 is constructed of burlap formed integral with a fertilizer admixture 32 of 12-48-8 derived from potassium nitrate, ammonium phosphate, copper EDTA, iron EDTA, manganese EDTA, zinc EDTA, sodium borate and ammonium molybdate water soluble fertilizer. Along with EDTA micronutrients, the phosphate blend is specifically designed to assist in plant nutrition over time. The fertilizer 32 being high in phosphorous helps transplants also overcome the initial shock of moving from a greenhouse to cooler conditions in the field.

Known water soluble fertilizers that are substantially similar to the proposed admixture 32 include: Miracle-Grot, Scotts®, Sunniland®, Milorganite®, Ironite®, Nitroform®, Andersons®, Safer Brand Solutions®, Nitro-Phos®, Lesco®, Purely Organic Products®, Pro Grow, Bayer®, AgroThrive®, Neptune's Harvest®, Grow More®, PROMOT® MZM, Growers®, Micro® (Cutting Edge Solutions), HAY-NOW®, FoxFarm®.

Additional agents added to the planting bag 10 may include: Herbicides, Pesticides, Fungicides, Nematode control, Root based nematode defense, and Mite Control. The planting bag 10 is prepared with the admixture of fertilizer, being integrated into the burlap structure by first liquefying the fertilizer with additional agents and soaking the planting bag in combination with super absorbent polymers, allowing water to evaporate causing the material to dry throughout the porosity within the structure of the burlap. The super absorbent polymers are capable of withholding the fertilizer and agents until released during rehydration. The burlap material forming the planting bag being treated contain a preselected amount of fertilizers 32 and pesticides 34, together with the water absorbent polymers 36 that are activated by a water delivery system 40 having an inlet positioned above ground level for water delivery below ground level 51.

As further shown in FIG. 1, burlap being the preferred material of construction of the planting bag 10, but various other materials can be substituted, including: cotton, wool, hemp, wood, wood fiber, bamboo, bamboo fiber, coconut, coconut fiber, corn fiber, wheat fiber, coir (all types), peat, recycled paper, grain husks and compressed soils. The planting bag having fertilizer and water absorbable polymer materials impregnated into the side of the planting bag by use of a press wherein the materials to be attached to the planting bag are placed under sufficient pressure to cause adhesion to the planting bag 10 materials of construction.

By trapping the fertilizer 32 and water absorbing polymer 36 in the planting bag 10 fabric, the roots of the plant are able to continue absorbing the fertilizer on a controlled basis long after moisture on the top surface has evaporated. The placement of the admixture and polymer within the porosity of the bag fabric, reduces the amount of fertilizer and/or other nutrients required to effectively grown the plant, and fertilizer run-off is eliminated or greatly reduced to avoid the adverse effects of fertilizer run-off.

The preferred polymer is a superabsorbent polymers constructed of crosslinked networks of ionic polymers capable of absorbing large amounts of water and retaining the absorbed water under pressure. The water retention capacity of these fiber-based products can be upwards of about 20 times their weight. The common crosslinked networks of ionic polymers sold are sodium polyacrylate (polyacrylic acid, sodium salt), typically crosslinked with a diacrylate or bisacrylamide, such as N,N′-methylene-bisacrylamide.

The super absorbent polymers have high water retention capacities, are non-toxic, and are biodegradable. Examples of these polymers are: cross-linked modified polyacrylamides/potassium acrylate or polyacrylamides/sodium acrylate. Other suitable polymers include, albeit not limited to, carboxy-methylcellulose, alginic acid, cross-linked starches, and cross-linked polyamino acids.

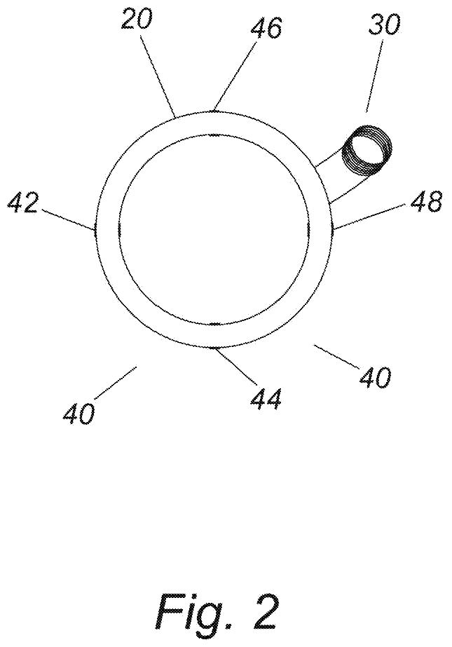

As shown in FIG. 2, the water delivery system 40 consists of a hose ring 18 coupled to a conventional garden hose fitting 30 constructed of plastic, brass or the like material. The hose ring 18 operates like a splitter feeding distribution lines 42, 44, 46 and 48.

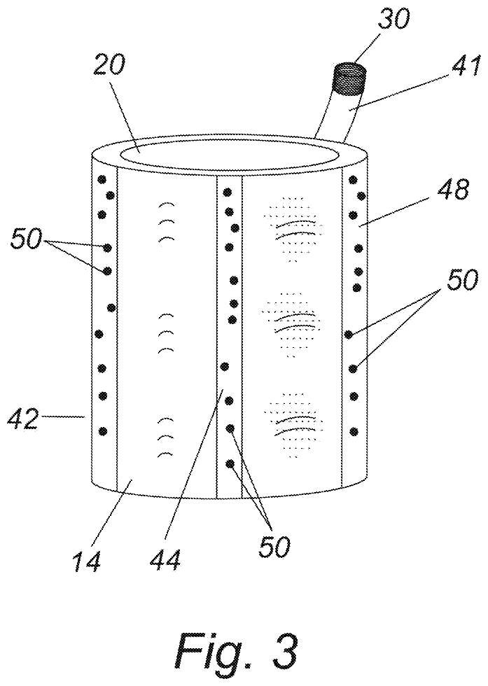

FIG. 3 is a front view of the garden hose ring with hose fitting attached and showing the irrigation holes along the surface of the perforated vertical hose sections. FIG. 3 illustrates the hose ring 20 of the water delivery system 40 with perforated vertical hose sections 42, 44, 46 and 48, each section having perforations 50 evenly spaced along the surface of the hose sections to provide water saturation along the surface of the planting bag 10 to aid in release of the fertilizers, insecticides and gel polymers which are embedded into the planting bag 10. Preferably the hose ring 20 and depending tubes are constructed from flexible hydro-biodegradable tubing wherein the tube can be enlarged, like a rubber band, to fit around a plant root ball. In approximately the same time that the planting bag and fertilizer has dissolved, the hose ring and tubing begins to degrade using bio-based sources such as corn, wheat or sugarcane. The biodegradable plastic can be decomposed by the microbes into water and biomass. In another embodiment, the water delivery system may remain within the soil wherein pressurized water and fertilizer is directed into the tubing for delivery beneath the soil surface.

The water delivery system 40 operates as a manifold to direct water beneath along the length of the hose sections 42, 44, 46 and 48. In a preferred embodiment a check valve 41 prevents water inserted into the piping assembly from being ejected when the filling hose is removed.

The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

It is to be understood that while a certain form of the invention is illustrated, it is not to be limited to the specific form or arrangement herein described and shown. It will be apparent to those skilled in the art that various changes may be made without departing from the scope of the invention, and that the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A planting bag comprising:
a biodegradable bag having a bottom wall, a continuous side wall secured to said bottom wall, and an open top;
a biodegradable water delivery system comprising at least two distribution lines secured to said continuous side wall and extending from said open top to said bottom wall, a splitter coupled to said distribution lines for coupling to a conventional water hose;
a fertilizer admixture impregnated into said side wall; and
a super absorbent polymer impregnated into said side wall.

2. The planting bag according to claim 1 including a predetermined nutrient impregnated into said side wall, said nutrient selected from the group consisting of: Herbicides, Pesticides, Fungicides, Nematode control, Root based nematode defense, or Mite Control.

3. The planting bag according to claim 1 wherein said planting bag is constructed from burlap.

4. The planting bag according to claim 1 wherein said planting bag is selected from the group consisting of burlap, cotton, wool, hemp, wood, wood fiber, bamboo, bamboo fiber, coconut, coconut fiber, corn fiber, wheat fiber, coir (all types), peat, recycled paper, grain husks and compressed soils.

5. The planting bag according to claim 1 wherein said fertilizer is an admixture of 12-48-8.

6. The planting bag according to claim 5 wherein said admixture contains: potassium nitrate, ammonium phosphate, copper EDTA, iron EDTA, manganese EDTA, zinc EDTA, sodium borate and ammonium molybdate.

7. The planting bag according to claim 1 wherein said fertilizer is a water soluble and selected from the group of water soluble fertilizers 32 sold as: Miracle-Gro®, Scotts®, Sunniland®, Milorganite®, Ironite®, Nitroform®, Andersons®, Safer Brand Solutions®, Nitro-Phos®, Lesco®, Purely Organic Products®, Pro Grow, Bayer®, AgroThrive®, Neptune's Harvest®, Grow More®, PROMOT® MZM, Growers®, Micro® (Cutting Edge Solutions), HAY-NOW®, FoxFarm®.

8. The planting bag according to claim 1 wherein said super absorbent polymer is constructed of crosslinked ionic polymer is a sodium polyacrylate.

9. The planting bag according to claim 1 wherein said super absorbent polymer is constructed of crosslinked modified polyacrylamides/potassium acrylate or polyacrylamides/sodium acrylate.
